(19) United States
(12) Patent Application Publication
(10) Pub. No.: US 2022/0142863 A1
(43) Pub. Date: May 12, 2022

(54) TRANSPORTABLE MEDICAL CONTAINER SYSTEM

(71) Applicant: Thaddeus Medical Systems, Inc., Rochester, MN (US)

(72) Inventors: Stephen Joseph Scully, JR., Rochester, MN (US); Russell Sanders, Minnetonka, MN (US)

(21) Appl. No.: 17/454,430

(22) Filed: Nov. 10, 2021

Related U.S. Application Data
(60) Provisional application No. 63/198,772, filed on Nov. 11, 2020.

(51) Int. Cl. A61J 1/16; G06Q 10/08; G06K 19/07; G06K 7/10; G08B 21/18

(52) U.S. Cl. CPC A61J 1/165; G06Q 10/0832; G06K 19/0723; G06K 7/10366; F25B 21/04; G08B 21/182; A61J 2205/60; A61J 2200/42; A61J 2200/44; G06K 7/10297

(57) ABSTRACT

A medical transport system can include a sleeve configured to receive a reservoir therein and a transport container including a compartment configured to receive the sleeve and the reservoir therein. The transport container can include a controller configured to receive from the sleeve an identity of the sleeve or the reservoir, verify the identity of the sleeve, and log receipt and storage of the sleeve.

### CLAIM OF PRIORITY

This patent application claims the benefit of priority, under 35 U.S.C. Section 119(e), to Stephen J. Scully, U.S. Patent Application Ser. No. 63/198,772, entitled “TRANSPORTABLE MEDICAL CONTAINER SYSTEM,” filed on Nov. 11, 2020 (Attorney Docket No. 4325.020PRV), which is hereby incorporated by reference herein in its entirety.

### BACKGROUND

Medical transport containers are often used when moving sensitive materials, such as blood samples, organs for transplant, vaccines, or the like. Often individual containers for vials, such as for vaccines or therapeutics, can be used to identify individual containers such as for delivery of different items to a single location or for the delivery of multiple items to different locations. Because the contents of the containers can be sensitive to temperature and can contain confidential materials (e.g., patient specimens) it can be important to monitor and track these vials.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of a medical transport system.

FIG. 2A illustrates a front view of a container in a transport sleeve.

FIG. 2B illustrates a front view of a transport sleeve.

FIG. 2C illustrates a cross-sectional view a transport sleeve across indicators 2C-2C of FIG. 2A.

FIG. 3 illustrates a system diagram of a medical transport system.

FIG. 4 is a block diagram illustrating an example of a machine upon which one or more embodiments may be implemented.

### DETAILED DESCRIPTION

Medical transport containers are used to transport a variety of organic materials or specimens, such as vaccines, blood samples, tissue samples, or organs for transplant. Transport can be from one hospital to another, from a hospital or clinic to an offside lab, or the like. In the case of transporting sensitive materials, there can be cases when the materials are transported a substantial distance, including from one state to another, or across multiple states or countries. In such examples, temperature can be regulated within the container to maintain viability of the transported material. However, it is difficult for a single container to track and monitor individual samples or containers that may be inserted into or removed from a larger container.

The inventors have recognized, among other things, that the individual containers can be enclosed or partially enclosed in individual monitoring containers or sleeves. The sleeves can be configured to individually maintain temperature of the individual container. The sleeves can each be in communication with the larger transport container to communicate data therebetween such as custody data.

The above discussion is intended to provide an overview of subject matter of the present patent application. It is not intended to provide an exclusive or exhaustive explanation of the invention. The description below is included to provide further information about the present patent application.

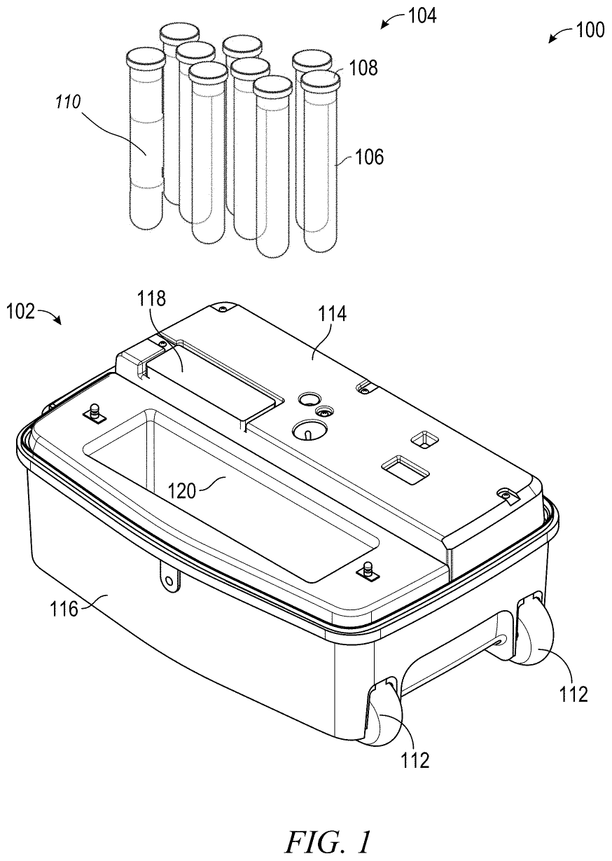

FIG. 1 illustrates a perspective view of a medical transport system 100 that can include a transport container 102 (optionally including a lid) and a plurality of individual containers 104, where each individual container 104 can include a vial 106, a cap 108, and a sleeve 110. The transport container 102 can include wheels 112, a temperature control system 114, a housing 116, a controller 118, and a compartment 120.

The temperature control system 114 can include a heater (such as an electric resistive heater) and a cooling system (such as a compress-powered refrigeration system) including a compressor, evaporator, condenser, one or more fans, or the like. The controller 118 can be a programmable controller, such as a single or multi-board computer, a direct digital controller (DDC), a programmable logic controller (PLC), or the like. In other examples the controller 118 can be any computing device, such as a handheld computer, for example, a smart phone, a tablet, a laptop, a desktop computer, or any other computing device including a processor, memory, and communication capabilities. The controller 118 can include or can be connected to a transceiver for sending and receiving transmissions.

The compartment 120 can be optionally covered by a lid and can be configured to receive the plurality of containers 104 therein. When the containers are located within the compartment, the container 102 can use the temperature control system 114 to maintain a temperature of the individual containers 104. The controller 118 and sensors of the container 102 can monitor the temperature(s) of the containers. Optionally, the controller 118 can receive temperature data from the individual containers 104. The controller 118 can also receive location data from the sleeve 110, such as to establish custody of the sleeve 110 and the container 104 and can use the location of the sleeves 110 of the containers 104 to do inventory management and transmit information about the inventory within the container 102.

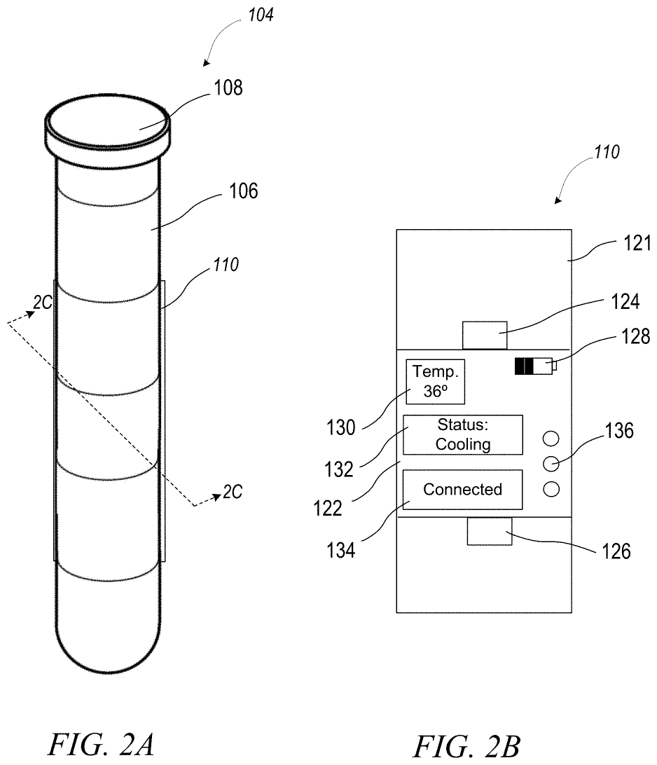

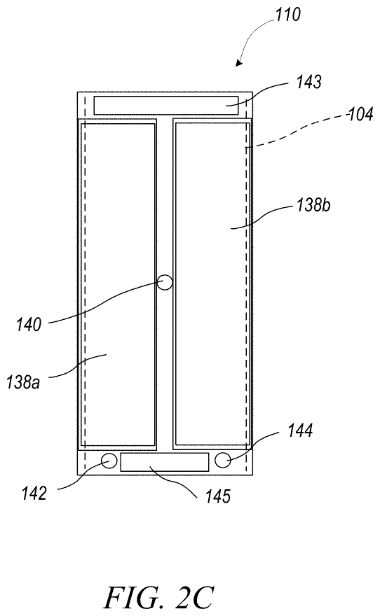

FIG. 2A illustrates a front view of the container 104 in the transport sleeve 110. FIG. 2B illustrates a front view of the transport sleeve 110. The transport sleeve can include a body 121, a user interface 122, an identification device (ID) 124, and an ambient sensor 126.

The user interface 122 can be a display or input device such as a touch screen or a display screen with buttons. The user interface 122 can be multiple screens. In some examples, the user interface 122 can be a digital ink user interface configured to display text or a variety of colors. The user interface 122 can be configured to present indications such as a battery charge indication 128, a temperature 130, a status indicator 132, and a communication status indicator 134. The user interface 136 can also include selectable indications 136, which can be touch-sensitive buttons (e.g., capacitive or resistive buttons) or physical buttons.

In an example where the user interface 122 is only a digital ink or includes a portion that is digital ink, the user interface 122 can be configured to display varying colors or indicators. For example, the digital ink can display a first color (e.g., green) when the sleeve 110 and container 104 have been maintained within a temperature range for a duration of the time that the container 104 is within the sleeve. The digital ink can display a second color (e.g., red) when the sleeve 110 and container 104 have not been maintained within a temperature range for a duration of the time that the container 104 is within the sleeve. Such an indication can allow a user (such as a physician administering a vaccine) to quickly determine whether the contents of the container are safe to use or administer.

The identification device 124 can be any active identification chip such as a radio frequency identification (RFID) chip, a near field communication (NFC) chip, or other chip configured to transmit identification data, such as an identification of the sleeve 110 or the vial 104. The active identification device can use long range or short range communication technologies. In some examples, the identification device 124 can be a passive identifier such as a bar code or a quick response (QR) code. The identification device can communicate with the transportation device 102 for identifying the sleeve 110 or the vial 104.

FIG. 2C illustrates a cross-sectional view the transport sleeve 110 across indicators 2C-2C of FIG. 2A. The transport sleeve 110 of FIG. 2C can be consistent with FIGS. 2A-2B discussed above; FIG. 2C shows additional components of the transport sleeve 110, such as thermoelectric heating and cooling devices (e.g., Peltier devices) 138a and 138b, an internal temperature sensor 140, and detection sensors 142 and 144.

The thermoelectric heating and cooling devices 138a and 138b can be powered to heat and cool the reservoir or vial 104 by a power source 143. The sleeve 110 can optionally include a controller 145 that can operate the heating and cooling devices 138a and 138b based on data (e.g., temperature readings) from the temperature sensor 140, from the ambient temperature sensor 126, or a setpoint that can be adjusted via the indications 136.

The detection sensors 142 or 144 can be optical scanners or sensors configured to detect the presence of objections. In some examples, the sensors 142 and 144 can be communicative sensors such as electromagnetic sensors (for example, a near field communication (NFC) sensor). The detection sensors 142 or 144 can be electrically connected to the controller 145 and can be configured to produce a detection signal based on the detection. In some examples, the detection sensors 142 or 144 can be pressure sensors or other detection sensors, such as one or more piezoelectric sensors or film.

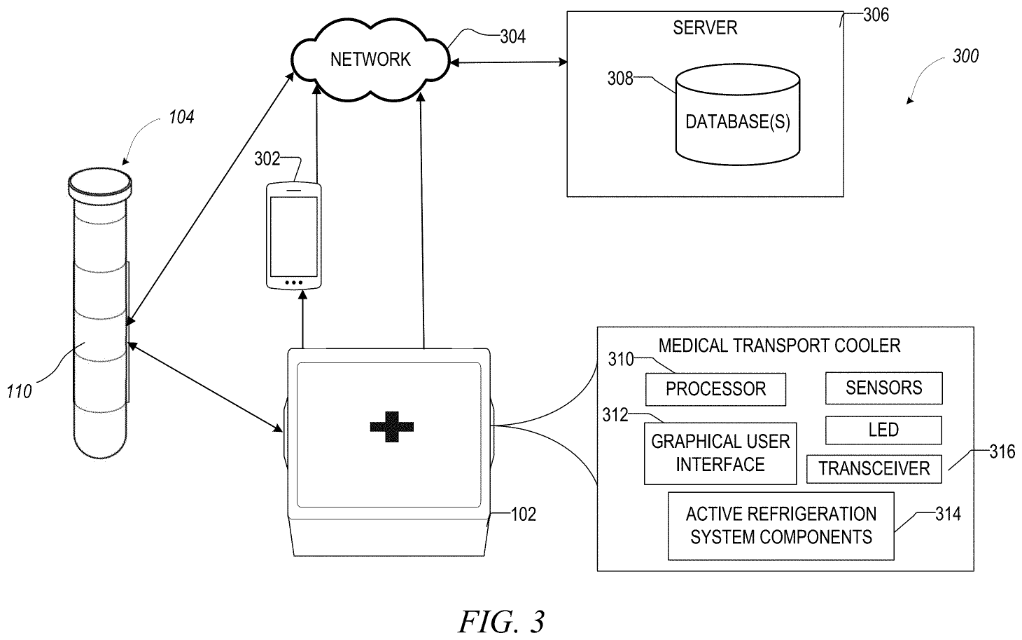

FIG. 3 illustrates a system diagram of a medical transport system 300. The system 300 can include the transport container 102, which may include a processor 310, a graphical user interface 312, a plurality of sensors, a light emitting diode (LED), a speaker, active refrigeration system components 314, or a transceiver 316. The transceiver 316 can include one or more antennas, for example a Wi-Fi antenna, a BLUETOOTH® antenna, an NFC (near field communication) reader or transmitter, an RFID (radio frequency identification) antenna, a cellular antenna (e.g., 3G, 4G, 5G, etc.), or the like. The transceiver 316 can communicate with a server, such as server a 306, which can include an email server to send data, or a remote server. The transceiver 316 can use one or more communication protocols to send data to various devices such as a user device 302, which can include a mobile device, a nearby device, a remote server, or the like.

The transceiver 316 may be powered or passive. The transceiver 316 may communicate intermittently (e.g., when there is data to send, such as when a buffer is full, or according to a periodic schedule) or via a continuous connection. Data or programs such as discussed herein can be sent to the medical transport container.

The medical transport container 102 can include circuitry to connect to the user device 302 (e.g., a smartphone, a tablet, a notebook computer, a desktop computer, or the like), or to a network 304. The network 304 may include a local area network (LAN), a wide area network (WAN), the internet, or the like. The network 304 may connect to the server 306. The server can contain a database 308 in which information regarding the sensors, status of the components included in the active refrigeration system components 314, or messages that can be sent to the graphical user interface 312 may be stored.

The active refrigeration system components 314, may include: a compressor, a condenser, a drive, an evaporator, a capillary, a drier, a fan, a controller, a battery, refrigerant, or the like. One or more of these components can be connected to respective one or more sensors, which can collect data from the components. The collected data can be classified using a classification model generated using a machine learning technique.

The medical transport container 102 may connect to the user device 302 in multiple ways. Such as, for example, through a universal serial bus (USB) cable, wireless local area networking (e.g. Wi-Fi), or any similar wireless technology (e.g. BLUETOOTH®). In an example, the medical transport container 102 can connect to the network 304 directly or through the user device 302.

The sleeve 110 can connect to the transport container through a transceiver of the sleeve 110 and can similarly connect to the network 304 through such a transceiver. The transceiver can use any of the wired or wireless technologies discussed above. The sleeve 110 can communicate vial or container detection, temperature, temperature setpoints, time of detect, time of removal, or the like to the container 102 or the network 304 for logging of such data.

This data can be used by the container 102, or the server 306 to maintain logs and a chain of custody for each sleeve 110 and therefore for each container 104 within each sleeve including whether each sleeve 110 and container 104 are within the container 102 or not and for what duration, which can help to for a detailed chain of custody for temperature sensitive and confidential materials that can be located within the containers 104.

This data can also be used for inventory management of the vials or containers 104 within the transportable container 102, such as keeping custody logs, temperature logs, and activity logs of each sleeve 110 and vial 104. The inventory management data can also be transferred from the sleeve(s) 110 or the container 102 to the network 304 and the server 306 to allow the server to perform inventory management.

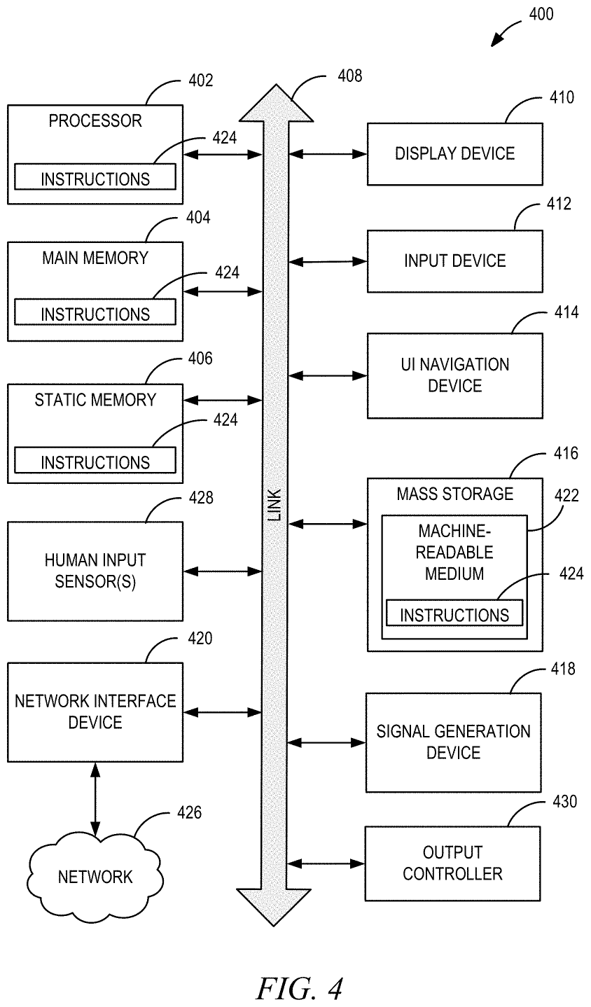

FIG. 4 illustrates a block diagram of an example machine Error! Reference source not found.00 upon which any one or more of the techniques (e.g., methodologies) discussed herein may perform. Examples, as described herein, may include, or may operate by, logic or a number of components, or mechanisms in the machine Error! Reference source not found.00. Circuitry (e.g., processing circuitry) is a collection of circuits implemented in tangible entities of the machine Error! Reference source not found.00 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, movable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation.

Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine Error! Reference source not found.00 follow.

In alternative embodiments, the machine Error! Reference source not found.00 may operate as a standalone device or may be connected (e.g., networked) to other machines. In a networked deployment, the machine Error! Reference source not found.00 may operate in the capacity of a server machine, a client machine, or both in server-client network environments. In an example, the machine Error! Reference source not found.00 may act as a peer machine in peer-to-peer (P2P) (or other distributed) network environment. The machine Error! Reference source not found.00 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) Error! Reference source not found.00 may include a hardware processor Error! Reference source not found.02 (e.g., a central processing unit (CPU), a graphics processing unit (GPU), a hardware processor core, or any combination thereof), a main memory Error! Reference source not found.04, a static memory (e.g., memory or storage for firmware, microcode, a basic-input-output (BIOS), unified extensible firmware interface (UEFI), etc.) Error! Reference source not found.06, and mass storage Error! Reference source not found.08 (e.g., hard drive, tape drive, flash storage, or other block devices) some or all of which may communicate with each other via an interlink (e.g., bus) Error! Reference source not found.30. The machine Error! Reference source not found.00 may further include a display unit Error! Reference source not found.10, an alphanumeric input device Error! Reference source not found.12 (e.g., a keyboard), and a user interface (UI) navigation device Error! Reference source not found.14 (e.g., a mouse). In an example, the display unit Error! Reference source not found.10, input device Error! Reference source not found.12 and UI navigation device Error! Reference source not found.14 may be a touch screen display. The machine Error! Reference source not found.00 may additionally include a storage device (e.g., drive unit) Error! Reference source not found.08, a signal generation device Error! Reference source not found.18 (e.g., a speaker), a network interface device Error! Reference source not found.20, and one or more sensors Error! Reference source not found.16, such as a global positioning system (GPS) sensor, compass, accelerometer, or other sensor. The machine Error! Reference source not found.00 may include an output controller Error! Reference source not found.28, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor Error! Reference source not found.02, the main memory Error! Reference source not found.04, the static memory Error! Reference source not found.06, or the mass storage Error! Reference source not found.08 may be, or include, a machine readable medium Error! Reference source not found.22 on which is stored one or more sets of data structures or instructions Error! Reference source not found.24 (e.g., software) embodying or utilized by any one or more of the techniques or functions described herein. The instructions Error! Reference source not found.24 may also reside, completely or at least partially, within any of registers of the processor Error! Reference source not found.02, the main memory Error! Reference source not found.04, the static memory Error! Reference source not found.06, or the mass storage Error! Reference source not found.08 during execution thereof by the machine Error! Reference source not found.00. In an example, one or any combination of the hardware processor Error! Reference source not found.02, the main memory Error! Reference source not found.04, the static memory Error! Reference source not found.06, or the mass storage Error! Reference source not found.08 may constitute the machine readable media Error! Reference source not found.22. While the machine readable medium Error! Reference source not found.22 is illustrated as a single medium, the term “machine readable medium” may include a single medium or multiple media (e.g., a centralized or distributed database, and/or associated caches and servers) configured to store the one or more instructions Error! Reference source not found.24.

The term “machine readable medium” may include any medium that is capable of storing, encoding, or carrying instructions for execution by the machine Error! Reference source not found.00 and that cause the machine Error! Reference source not found.00 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions Error! Reference source not found.24 may be further transmitted or received over a communications network Error! Reference source not found.26 using a transmission medium via the network interface device Error! Reference source not found.20 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device Error! Reference source not found.20 may include one or more physical jacks (e.g., Ethernet, coaxial, or phone jacks) or one or more antennas to connect to the communications network Error! Reference source not found.26. In an example, the network interface device Error! Reference source not found.20 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine Error! Reference source not found.00, and includes digital or analog communications signals or other intangible medium to facilitate communication of such software. A transmission medium is a machine readable medium.

### NOTES AND EXAMPLES

The following, non-limiting examples, detail certain aspects of the present subject matter to solve the challenges and provide the benefits discussed herein, among others.

Example 1 is a medical transport system comprising: a sleeve configured to receive a reservoir therein, the sleeve including an identification device; and a transport container including an active heating and cooling system and a compartment configured to receive the sleeve and the reservoir therein, the transport container including a controller configured to: receive from the sleeve an identity of the sleeve or the reservoir; verify the identity of the sleeve; and log receipt and storage of the sleeve.

In Example 2, the subject matter of Example 1 optionally includes wherein controller is further configured to: receive temperature data from the sleeve; and adjust a temperature setpoint of the active heating and cooling system based on the temperature data and the identity of the sleeve or the reservoir.

In Example 3, the subject matter of any one or more of Examples 1-2 optionally include wherein the sleeve includes a thermoelectric heating and cooling system.

In Example 4, the subject matter of any one or more of Examples 1-3 optionally include wherein the identification device is an RFID, NFC, or Bluetooth identification chip.

In Example 5, the subject matter of any one or more of Examples 1-4 optionally include wherein controller is further configured to: determine, based on the log of receipt and storage of the device, a chain of custody of the sleeve.

In Example 6, the subject matter of any one or more of Examples 2-5 optionally include wherein controller is further configured to: determine, based on the log of receipt and storage of the device, if the sleeve is within the transport container.

In Example 7, the subject matter of Example 6 optionally includes wherein controller is further configured to: determine, based on the log of receipt and storage of the device, a duration that the sleeve is out of the transport container.

In Example 8, the subject matter of Example 7 optionally includes wherein controller is further configured to: produce an alert based on the temperature of the sleeve and the duration that the sleeve is out of the transport container.

Example 9 is a non-transitory machine-readable medium including instructions, for tracking a sleeve or a reservoir of the sleeve within a transport container, which when executed by a machine, cause the machine to: receive from the sleeve an identity of the sleeve or the reservoir from an identification device of the sleeve; verify the identity of the sleeve; and log receipt and storage of the sleeve in the transport container.

In Example 10, the subject matter of Example 9 optionally includes the instructions to further cause the machine to: receive temperature data from the sleeve; and adjust a temperature setpoint of an active heating and cooling system based on the temperature data and the identity of the sleeve or the reservoir.

In Example 11, the subject matter of any one or more of Examples 9-10 optionally include wherein the sleeve includes a thermoelectric heating and cooling system.

In Example 12, the subject matter of any one or more of Examples 9-11 optionally include wherein the identification device is an RFID, NFC, or Bluetooth identification chip.

In Example 13, the subject matter of any one or more of Examples 9-12 optionally include wherein controller is further configured to: determine, based on the log of receipt and storage of the device, a chain of custody of the sleeve.

In Example 14, the subject matter of any one or more of Examples 10-13 optionally include the instructions to further cause the machine to: determine, based on the log of receipt and storage of the device, if the sleeve is within the transport container.

In Example 15, the subject matter of Example 14 optionally includes the instructions to further cause the machine to: determine, based on the log of receipt and storage of the device, a duration that the sleeve is out of the transport container.

In Example 16, the subject matter of Example 15 optionally includes the instructions to further cause the machine to: produce an alert based on the temperature of the sleeve and the duration that the sleeve is out of the transport container.

Example 17 is at least one machine-readable medium including instructions that, when executed by processing circuitry, cause the processing circuitry to perform operations to implement of any of Examples 1-16.

Example 18 is an apparatus comprising means to implement of any of Examples 1-16.

Example 19 is a system to implement of any of Examples 1-16.

Example 20 is a method to implement of any of Examples 1-16.

In Example 21, the apparatuses or method of any one or any combination of Examples 1-20 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A medical transport system comprising:
a sleeve configured to receive a reservoir therein, the sleeve including an identification device; and
a transport container including an active heating and cooling system and a compartment configured to receive the sleeve and the reservoir therein, the transport container including a controller configured to:
receive from the sleeve an identity of the sleeve or the reservoir;
verify the identity of the sleeve; and
log receipt and storage of the sleeve.

2. The medical transport system of claim 1, wherein controller is further configured to:
receive temperature data from the sleeve; and
adjust a temperature setpoint of the active heating and cooling system based on the temperature data and the identity of the sleeve or the reservoir.

3. The medical transport system of claim 1, wherein the sleeve includes a thermoelectric heating and cooling system.

4. The medical transport system of claim 1, wherein the identification device is an RFID, NFC, or Bluetooth identification chip.

5. The medical transport system of claim 1, wherein controller is further configured to:
determine, based on the log of receipt and storage of the device, a chain of custody of the sleeve.

6. The medical transport system of claim 2, wherein controller is further configured to:
determine, based on the log of receipt and storage of the device, if the sleeve is within the transport container.

7. The medical transport system of claim 6, wherein controller is further configured to:
determine, based on the log of receipt and storage of the device, a duration that the sleeve is out of the transport container.

8. The medical transport system of claim 7, wherein controller is further configured to:
produce an alert based on the temperature of the sleeve and the duration that the sleeve is out of the transport container.

9. A non-transitory machine-readable medium including instructions, for tracking a sleeve or a reservoir of the sleeve within a transport container, which when executed by a machine, cause the machine to:
receive from the sleeve an identity of the sleeve or the reservoir from an identification device of the sleeve;
verify the identity of the sleeve; and
log receipt and storage of the sleeve in the transport container.

10. The non-transitory machine-readable medium of claim 9, the instructions to further cause the machine to:
receive temperature data from the sleeve; and
adjust a temperature setpoint of an active heating and cooling system based on the temperature data and the identity of the sleeve or the reservoir.

11. The non-transitory machine-readable medium of claim 9, wherein the sleeve includes a thermoelectric heating and cooling system.

12. The non-transitory machine-readable medium of claim 9, wherein the identification device is an RFID, NFC, or Bluetooth identification chip.

13. The non-transitory machine-readable medium of claim 9, wherein controller is further configured to:
determine, based on the log of receipt and storage of the device, a chain of custody of the sleeve.

14. The non-transitory machine-readable medium of claim 10, the instructions to further cause the machine to:
determine, based on the log of receipt and storage of the device, if the sleeve is within the transport container.

15. The non-transitory machine-readable medium of claim 14, the instructions to further cause the machine to:
determine, based on the log of receipt and storage of the device, a duration that the sleeve is out of the transport container.

16. The non-transitory machine-readable medium of claim 15, the instructions to further cause the machine to:
produce an alert based on the temperature of the sleeve and the duration that the sleeve is out of the transport container.
